(19) United States
(12) Patent Application Publication
(10) Pub. No.: US 2007/0066468 A1
(43) Pub. Date: Mar. 22, 2007

(54) Conductive transfer roller usable with image forming apparatus

(76) Inventor: In Kim, Suwon-si (KR)

Correspondence Address: STANZIONE & KIM, LLP, 919 18TH STREET, N.W., SUITE 440, WASHINGTON, DC, 20006, US

(21) Appl. No.: 11/363,170

(22) Filed: Feb. 28, 2006

(30) Foreign Application Priority Data
Sep. 16, 2005 (KR) 2005-86958

(51) Int. Cl. F16C 13/00

(52) U.S. Cl. 492/56; 29/895.32

(57) ABSTRACT

A conductive transfer roller for an image forming apparatus comprises an elastomer foam formed by blowing a blended raw material, which includes elastomer, 1-4 phr of liquid thiophene as conductive material, and 0.2-6 phr of wood powder as nucleating agent. The transfer roller has a uniform cell size and distribution, thereby having a superior elasticity, which enables the transfer roller to have a desired level of resistance in terms of conductivity and is environment-friendly.

### CROSS-REFERENCE TO RELATED APPLICATIONS

This application claims the benefit under 35 U.S.C. §119 of Korean Patent Application No. 2005-86958 filed on Sep. 16, 2005 in the Korean Intellectual Property Office, the disclosure of which is incorporated herein by reference.

### BACKGROUND OF THE INVENTION

1. Field of the Invention

The present general inventive concept relates to a conductive transfer roller usable with an image forming apparatus, and more particularly, to a conductive transfer roller formed from an elastomer foam, which has cells that are uniform in size and distribution.

2. Description of the Related Art

An electrophotographic image forming apparatus, such as a printer, a facsimile, and a copying machine, transfers an image formed on a photoconductor to a paper through a transfer roller.

FIG. 1 illustrates structure of a conventional electrophotographic image forming apparatus. Referring to FIG. 1, in the conventional electrophotographic image forming apparatus 10, a surface of an optical photoconductive drum 12 is charged by a charging roller 11, and then a latent image is formed on the surface of the optical photoconductive drum 12 by a laser scanning unit 13. Thereafter, toner T provided by a developer roller 14 is selectively deposited on the latent image, thereby forming a toner image, and the toner image is transferred on a paper S passing through a contact area (i.e., a transfer nip) between a transfer roller 20 and the optical photoconductive drum 12, as the optical photoconductive drum 12 rotates. The paper S is fed from a paper cassette 17 by a pickup roller 17a and conveyed to the transfer roller 20.

A high voltage, having a polarity opposite to that of the toner, is applied to the transfer roller 20, so that the toner on the optical photoconductive drum 12 is electrostatically attracted towards the transfer roller 20, thereby transferring the toner image to the paper S fed between the optical photoconductive drum 12 and the transfer roller 20. A rear surface of the paper S is supplied with transfer charge, having a polarity opposite to that of the toner, so that the transferred toner adheres to and remains on an upper surface of the paper S when the toner is electrostatically attracted and the toner image is transferred on the paper S. The paper S, to which the toner image is transferred, is heated and compressed by a fixing unit 15, whereby the toner image is fused to the paper S.

FIG. 2 illustrates a structure of the transfer roller 20 included in the conventional image forming apparatus of FIG. 1. As illustrated in FIG. 2, the transfer roller 20 includes a support member 21, an elastic layer 22 attached on a peripheral surface of the support member 21, and an adhesion layer 23 interposed between the support member 21 and the elastic layer 22. In order to increase an endurance and reduce a surface friction force, the transfer roller 20 may be formed with a coating layer 24 on an outer surface of the elastic layer 22.

The elastic layer 22 is formed of an elastomer foam, which is a non-conductive material, usually being an elastomer-based material like rubber. In general, the elastomer foam is a type of nitril butadiene rubber (NBR), a polyurethane foam, a silicon foam, an acrylonitril butadiene rubber foam, an ethylene propylene diene terpolymer (EPDM) foam, or other rubber blend foam.

The transfer roller 20 having the structure illustrated in FIG. 2 and described above should be conductive in order to supply a transfer charge to the paper S so that the toner image is transferred to the paper S due to an electrostatic attraction of the toner to the paper S, which is stronger than an electrostatic attraction of a photoconductor, such as the photoconductive drum 12 (see FIG. 1). Conventionally, in order to make the elastic layer 22 conductive, carbon black, metal powder, fiber, conductive polymer, ionic salt, anti-static agent or the like is added to or dispersed in the elastomer.

Although the carbon black is most frequently added to the elastomer in order to provide a non-conductive elastomer material with conductivity, a range of resistance implemented by the carbon black is limited to a low level of resistance. In addition, if a large amount of carbon black is blended, the Shore hardness of the elastic layer 22 (see FIG. 2) increases. When the Shore hardness of the elastic layer 22 increases, a contact area between the photoconductor and the transfer roller 20 for providing a sufficient transfer effect decreases, thereby deteriorating transfer efficiency of the elastic layer 22 of the transfer roller 20 of FIG. 2. Therefore, there is a limitation in implementing an intermediate level of resistance (or hardeness) in a transfer roller by using carbon black, and, in particular, there is a problem in that the use of the carbon black causes a deviation in resistance or in the Shore hardness of the transfer roller 20 and a contamination in a background of the transferred toner image.

In order to avoid this problem, ionic conductive salt or anti-static agent has been used as the conductive additive. For example, to provide the non-conducting elastomer foam with ionic conductivity, epichlorohydrin rubber or alkyl sulfonic acid based salt, or the like may be added to or dispersed in the elastomer foam. However, a transfer roller made of the elastomer foam having such a salt or an anti-static agent has a disadvantage in that the salt or anti-static agent migrates to the surface of the transfer roller and therefore generates fluctuation of resistance that may adversely affect the transferred toner image. In this case, a transfer voltage should be changed or adjusted depending on the fluctuation of the resistance. In particular, it is generally difficult to disperse the above-mentioned conductive additives in the elastomer foam, which is an obstacle in keeping a foaming density of the elastomer foam uniform.

In addition, a poor dispersion of the carbon black or the salt in the elastomer foam causes a problem in manufacturing the transfer roller. In particular, if the above-mentioned conductive additives are provided in a blended form when manufacturing the elastomer foam, the elastomer foam is not uniform in cell size and distribution, whereby adversely affecting the endurance and functionality of the transfer rollers made of the above-described elastomer foam.

### SUMMARY OF THE INVENTION

The present general inventive concept provides a transfer roller made of elastomer foam and usable with an image forming apparatus, in which the elastomer foam has a relatively increased foam density, a uniform cell size and density, and a superior elasticity, and in which a desired level of resistance can be implemented in terms of conductivity. The transfer roller is also environment-friendly, by employing liquid thiophene as a conductive material and wood powder as a nucleating agent when manufacturing the elastomer foam of the transfer roller.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a conductive transfer roller usable with an image forming apparatus, comprising an elastomer foam formed by blowing a blended raw material which includes an elastomer, a liquid thiophene as a conductive material, and a wood powder as nucleating agent.

The elastomer may be selected from a group consisting of EPDM/NBR, PVC/EPDM, PE/EPDM, NBR, polyurethane, silicon, SBS, SEBS, or the other elastomer.

An amount of the liquid thiophene in the elastomer foam may be in a range of about 1 to 4 phr with respect to the weight of the elastomer.

An amount of the wood powder is the elastomer foam may be in a range of 0.2 to 6 phr. The amount of the wood powder in the elastomer foam may be in a range of 0.4 to 4.5 phr with respect to the weight of the elastomer. A particle size of the wood powder may be in a range of 30 to 120 μm.

The elastomer foam may be blown using a chemical blowing agent, which may be one of azodicarbonamide, p,p′-oxybis(benzenesulfonylhydrazide), p-toluene-sulfonylhydrazide, N,N′-dinitrosopentamethylenetetramine, and benzene-sulfonyhydrazide.

A thermal stabilizer may be additionally included in the blended raw material, and the thermal stabilizer may be one of Ba—Zn based powder, dioctyl phthalate (DOP), bis(2-ethylhexyl)phthalate, and naphthene-based oil.

The elastomer foam may have a cell size in a range of 50 to 120 μm and a cell density in a range of 0.5×10⁶ to 9.0×10⁶ cells/cm².

The conductive transfer roller may have a resistance in a range of 10³ to 10⁹Ω and a Shore hardness in a range of 53 to 45 Shore-C scale.

The foregoing and/or other aspects of the present general inventive concept may also be achieved by providing an elastomer foam comprising one or more elastomers, a conductive additive material, and a nucleating agent.

The foregoing and/or other aspects of the present general inventive concept may also be achieved by providing an image forming apparatus comprising a conductive transfer roller having an elastomer foam formed by blowing a blended raw material, the blended raw material comprising an elastomer, a liquid thiophene as a conductive material, and a wood powder as a nucleating agent.

The foregoing and/or other aspects of the present general inventive concept may also be achieved by providing a conductive transfer roller comprising an elastic layer made of an elastomer foam comprising one or more elastomers, a conductive additive material, and a nucleating agent.

The foregoing and/or other aspects of the present general inventive concept may also be achieved by providing a method of making an elastomer foam, the method comprising adding a conductive material and a nucleating agent to one or more elastomers to form a blend, and adding at least one chemical blowing agent to the blend to form an elastomer foam.

The foregoing and/or other aspects of the present general inventive concept may also be achieved by providing a method of making a transfer roller of an image forming apparatus, the method comprising molding an elastomer foam made of one or more elastomers, a conductive material, and a nucleating agent using an extruder.

### BRIEF DESCRIPTION OF THE DRAWINGS

These and/or other aspects and advantages of the present general inventive concept will become apparent and more readily appreciated from the following description of the embodiments taken in conjunction with the accompanying drawings, in which:

FIG. 1 is a view schematically illustrating a structure of a conventional image forming apparatus;

FIG. 2 illustrates a transfer roller of the conventional image forming apparatus of FIG. 1; and

FIG. 3 illustrates a part of an extruder for injection molding suitable for manufacturing a transfer roller usable with an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

A conductive transfer roller usable with an image forming apparatus according to an embodiment of the present general inventive concept is an elastic roller having an elastic layer made of foam formed by blowing an elastomer based material, which is a non-conductive material.

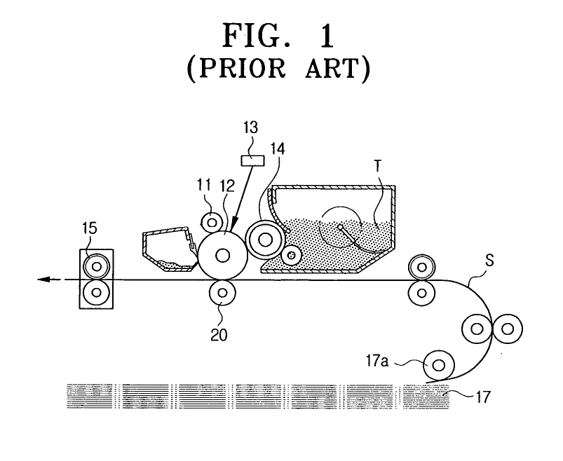

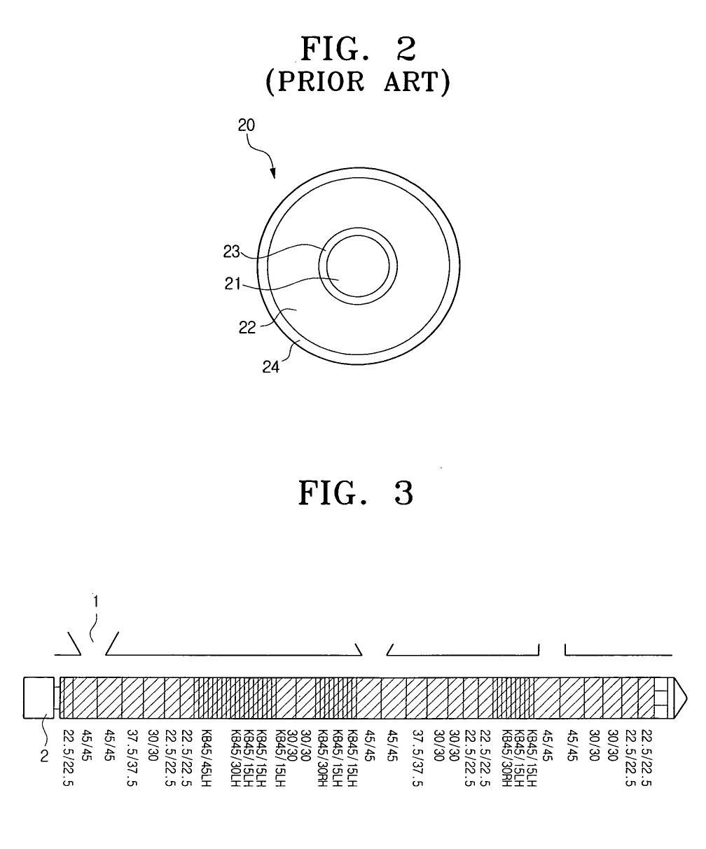

The image forming apparatus includes components similar to a conventional image forming apparatus of FIG. 1 except the conductive transfer roller formed according to the present embodiment, and the transfer roller of the present embodiment has the similar structure to a conventional roller as shown in FIG. 2. However, the transfer roller of the present embodiment is different from the conventional roller of FIG. 2 in materials and manufacturing process which will be described hereinafter.

The conductive transfer roller according to the present embodiment employs a high molecular weight elastomer, which is superior in elasticity, as a base material. The elastomer foam may be a nitrile rubber (NBR) foam, a polyurethane foam, a silicon foam, an acrylonitril butadiene rubber, ethylene propylene diene monomer (EPDM) foam, or other rubber blend foam. The elastomer suitable can be one of EPDM/NBR, PVC/EPDM (where PVC is polyvinylchloride), PE/EPDM (where PE is polyethylene), NBR, polyurethane, silicon, Styrene Butadiene Styrene (SBS), Styrene-Ethylene-Butadiene-Styrene (SEBS), and the like.

A liquid thiophene is a heterocyclic compound with sulfur in each chain, which exhibits a conductive function when it is added to an elastomer. The liquid thiophene makes it possible to implement various levels of resistance in the elastomer depending on the added amount thereof. In addition, even if a large amount of liquid thiophene is added, the Shore hardness of the elastic layer in a transfer roller can be maintained substantially constant. In addition, the liquid thiophene can be easily dispersed in the elastomer and the use of the liquid thiophene provides a uniform foaming density of the elastomer. Therefore, the liquid thiophene is added to the elastomer in a range of at least about 1 phr (parts-per-hundred rubber) with respect to the weight of the elastomer. However, when the added liquid thiophene is more than 4 phr with respect to the weight of the elastomer, the resistance is not changed any more.

Wood powder added to the elastomer serves to nucleate in the elastomer, and a cell size and density of the elastomer foam may be controlled by varying an amount of the wood powder to be added. That is, when the elastomer is blown to form the elastomer foam, the wood powder serves to nucleate within the elastomer foam, whereby the cell size of the elastomer foam can be reduced, and cells having a reduced cell size are uniformly and densely distributed in the elastomer form. As a result, the elastomer foam has a relatively high and uniform density and a superior elasticity, which enables to implement a desired level of resistance. If the amount of wood powder is increased in the elastomer foam, it is possible to manufacture a transfer roller, in which the cell size is reduced and the elastomer foam density is increased. However, if the amount of the wood powder is too low, it cannot serve to sufficiently nucleate, and if the amount is too high, the nucleating effect of the wood powder is not improved any more. According to an embodiment of the present general inventive concept, the amount of the wood powder added in the elastomer is in a range of about 0.2 to about 6 phr, and optimally within a range of about 0.4 to about 4.5 phr with respect to the weight of the elastomer. A particle size of the wood powder used is in a range of about 30 to about 120 μm. If the particle size of the wood powder is reduced, the cell size is reduced and the cell density is increased.

When a chemical blowing agent is added in the elastomer, bubbles are formed, thereby forming an elastomer foam. In the present embodiment, a proper amount of the chemical blowing agent to be added to form the elastomer foam is typically in a range of 5 to 7 phr with respect to the weight of the elastomer. If the added amount of the chemical blowing agent is too low, its blowing effect is not sufficient, and if the amount is too high, cells in the elastomer foam may collapse due to multiple foaming. The chemical blowing agent suitable for the present embodiment may be one of azodicarbonamide, p,p′-oxybis(benzenesulfonylhydrazide), p-toluene-sulfonylhydrazide, N,N′-dinitrosopentamethylenetetramine, and benzene-sulfonyhydrazide. Among them, the azodicarbonamide is most suitable. The azodicarbonamide is expressed by following chemical formula and has a decomposition temperature is in a range of 160 to 180° C.

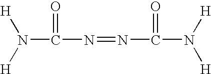

To avoid collapse of the cells of the elastomer foam, a thermal stabilizer can be added to form a blended raw material. The thermal stabilizer may be selected from a group consisting of Ba—Zn based powder, bis(2-ethylhexyl)phthalate, and naphthene-based oil. Because the cells may still collapse if an added amount of thermal stabilizer is too low or high, the suitable amount of thermal stabilizer to be added is in a range of about 2.5 to about 7 phr with respect to the weight of the elastomer.

If the blended raw material prepared as described above is loaded into and molded by a conventional extruder, it is possible to obtain the elastomer foam having a predetermined shape. FIG. 3 illustrates a detailed configuration of a modular twin screw extruder that is used to mold a blended raw material according to an embodiment of the present general inventive concept. Referring to FIG. 3, if the blended raw material in a hopper (not shown) is charged to fill or load the extruder through a feeding hole 1 of the extruder, a screw 2 extrudes the blended row material toward a die (not shown) positioned at a right side of FIG. 3 while rotating, thereby manufacturing a transfer roller having a desired shape. FIG. 3 shows numbers and characters, such as 22.5, 30, 45, KB45, 15LH, etc., which relate to screw configuration of the modular twin screw excluder, such as descriptions corresponding to screw elements thereof.

The elastomer foam manufactured as described above is very uniform in cell size and density, the cell size being in a range of about 50 to about 120 μm and the cell density being in a range of about 0.5×10⁶ to about 9.0×10⁶ cells/cm². In addition, the conductive transfer roller formed from the elastomer foam has a Shore hardness in a range of about 35 to about 45 Shore-C scale and has a resistance in a range of about 10³ to about 10⁹Ω.

Transfer rollers were manufactured using four blended raw material (Examples 1 to 4) having a respective blending composition is specified in Table 1. The blended raw material includes poly propylene (PP) and EPDM (50/50% by weight) as the base material of the transfer rollers, Ba—Zn as the thermal stabilizer, and azodicarbonamide as the chemical blowing agent. In Examples 1 to 4, an amount of wood powder having the particle size in the range of 30 to 50 μm, was used in the blended raw material as follows.

TABLE 1
Composition of blended raw material (unit: phr)

| | Example 1 | Example 2 | Example 3 | Example 4 |
|---|---|---|---|---|
| PP/EPDM | 100 | 100 | 100 | 100 |
| Liquid thiophene | 1.0 | 2.0 | 3.0 | 4.0 |
| Chemical blowing agent | 7 | 7 | 7 | 7 |
| Thermal stabilizer | 3 | 3 | 3 | 3 |
| Wood powder | 0.4 | 0.9 | 2.0 | 4.5 |

The blended raw material was injection-molded by using a modular twin screw extruder having the screw configuration illustrated in FIG. 3 and according to a temperature condition corresponding to zones as specified in Table 2.

TABLE 2
Temperature in Extruder (° C.)

| Die | Zone-5 | Zone-4 | Zone-3 | Zone-2 | Zone-1 | Hopper |
|---|---|---|---|---|---|---|
| 200 | 190 | 190 | 190 | 190 | 170 | 80 |

The cell size, cell density, surface Shore hardness, and resistance for the transfer rollers (Example 1 to 4) manufactured were measured at a temperature of 23° and a humidity of 55% as provided in Tables 3 and 4.

TABLE 3

| | Example 1 | Example 2 | Example 3 | Example 4 |
|---|---|---|---|---|
| Cell diameter (μm) | 100 ± 10 | 95 ± 10 | 90 ± 10 | 50 ± 10 |
| of the foam | | | | |
| Cell density | 1.2 ± 0.1 | 1.6 ± 0.1 | 2.5 ± 0.1 | 7.0 ± 0.3 |
| of the foam | | | | |
| (10⁶ cells/cm²) | | | | |

TABLE 4

| | Example 1 | Example 2 | Example 3 | Example 4 |
|---|---|---|---|---|
| Shore Hardness | 36 ± 2 | 37 ± 2 | 36 ± 2 | 37 ± 2 |
| (Shore-C scale) | | | | |
| Resistance (Ω) | 10⁸ | 10⁷ | 10⁶ | 10⁴ |

Four other transfer rollers (Examples 5 to 8) were manufactured using the same blended raw material and the same extruder as used in Examples 1 to 4, respectively, except that the particle size of the wood powder was in the range of 60 to 120 μm. The cell diameter, cell density, surface Shore hardness and resistance of the transfer rollers manufactured thereby were measured, as provided in Tables 5 and 6.

TABLE 5

| | Example 5 | Example 6 | Example 7 | Example 8 |
|---|---|---|---|---|
| Cell diameter (μm) | 120 ± 10 | 118 ± 10 | 105 ± 10 | 50 ± 10 |
| of the foam | | | | |
| Cell density | 1.0 ± 0.1 | 1.3 ± 0.1 | 1.5 ± 0.1 | 7.5 ± 0.2 |
| of the foam | | | | |
| (10⁶ cells/cm²) | | | | |

TABLE 6

| | Example 5 | Example 6 | Example 7 | Example 8 |
|---|---|---|---|---|
| Shore Hardness | 35 ± 2 | 36 ± 2 | 34 ± 2 | 35 ± 2 |
| (Shore-C scale) | | | | |
| Resistance (Ω) | 10⁸ | 10⁷ | 10⁶ | 10⁴ |

Comparing Tables 3 and 4 with Tables 5 and 6, the transfer rollers of Examples 5 to 8 are substantially same with those of Examples 1 to 4 in cell size and distribution of the foam and capable of having a lower level of resistance even if the particle size of the wood powder is large. Therefore, according to Examples 5 to 8, a desired level of resistance may be implemented to determine conductivity of the transfer roller.

As described above, the conductive transfer roller according to various embodiments of the present general inventive concept has an extended life time because the cell size and density in elastomer foam is uniform. By manufacturing the elastomer foam, so that the elastomer foam is superior in elasticity and substantially constant in Shore hardness, the endurance of the elastomer foam is improved.

Furthermore, the transfer roller according to embodiments of the present general inventive concept is environment-friendly because a migration problem can be basically avoided by using liquid thiophene when manufacturing elastomer foam.

In addition, the conductive transfer roller according to various embodiments of the present general inventive concept can basically prevent the deterioration of quality of image caused by poor transfer, because the cell size and density in the elastomer foam of the transfer roller can be controlled by properly varying the content of liquid thiophene and wood powder when manufacturing the elastomer foam, thereby implementing a desired level of resistance determining the conductivity.

Although representative embodiments of the present general inventive concept have been shown and described in order to exemplify the principle of the present general inventive concept, the present general inventive concept is not limited to the specific embodiments. It will be understood that various modifications and changes can be made by one skilled in the art without departing from the spirit and scope of the general inventive concept as defined by the appended claims. Therefore, it shall be considered that such modifications, changes and equivalents thereof are all included within the scope of the present general inventive concept.

What is claimed is:

1. A conductive transfer roller usable with an image forming apparatus, comprising:
an elastomer foam formed by blowing a blended raw material, the blended raw material comprising an elastomer, a liquid thiophene as a conductive material, and a wood powder as a nucleating agent.

2. The conductive transfer roller as claimed in claim 1, wherein the elastomer is selected from a group consisting of EPDM/NBR, PVC/EPDM, PE/EPDM, NBR, polyurethane, silicon, SBS, and SEBS.

3. The conductive transfer roller as claimed in claim 1, wherein an amount of liquid thiophene in the elastomer foam is at least 1 phr with respect to the weight of the elastomer.

4. The conductive transfer roller as claimed in claim 3, wherein an amount of the liquid thiophene in the elastomer foam is in a range of 1 to 4 phr with respect to the weight of the elastomer.

5. The conductive transfer roller as claimed in claim 1, wherein an amount of wood powder in the elastomer foam is in a range of 0.2 to 6 phr with respect to the weight of the elastomer.

6. The conductive transfer roller as claimed in claim 5, wherein the amount of the wood powder in the elastomer foam is in a range of 0.4 to 4.5 phr with respect to the weight of the elastomer.

7. The conductive transfer roller as claimed in claim 5, wherein a particle size of the wood powder is in a range of 30 to 120 μm.

8. The conductive transfer roller as claimed in claim 1, wherein the elastomer foam is blown using a chemical blowing agent selected from a group consisting of azodicarbonamide, p,p′-oxybis(benzenesulfonylhydrazide), p-toluene-sulfonylhydrazide, N,N′-dinitrosopentamethylenetetramine, and benzenesulfonyhydrazide.

9. The conductive transfer roller as claimed in claim 1, wherein the blended raw material further includes a thermal stabilizer.

10. The conductive transfer roller as claimed in claim 9, wherein the thermal stabilizer is selected from a group consisting of Ba—Zn based powder, dioctyl phthalate (DOP), bis(2-ethylhexyl)phthalate, and naphthene-based oil.

11. The conductive transfer roller as claimed in claim 1, wherein the elastomer foam has a cell size in a range of 50 to 120 μm and a cell density in a range of 0.5×10⁶ to 9.0×10⁶ cells/cm².

12. The conductive transfer roller as claimed in claim 1, wherein the conductive transfer roller has a resistance in a range of 10³ to 10⁹Ω and a Shore hardness in a range of 35 to 45 Shore-C scale.

13. An image forming apparatus, comprising:
a conductive transfer roller having an elastomer foam formed by blowing a blended raw material, the blended raw material comprising an elastomer, a liquid thiophene as a conductive material, and a wood powder as a nucleating agent.

14. The apparatus as claimed in claim 13, wherein the conductive transfer roller comprises a support member, an adhesion layer formed on the support member, and a coating layer, and the elastomer foam is disposed between the adhesion layer and the coating layer as the conductive transfer roller.

15. The apparatus as claimed in claim 13, further comprising:
a photoconductive drum to form a toner image,
wherein the conductive transfer roller controls the toner image to be transferred from the photoconductive drum to a printing medium.

16. The apparatus as claimed in claim 13, wherein the conducting transfer roller has a Shore hardness between about 35 and about 45 on a Shaore-C scale.

17. The conductive roller of claim 13, wherein the conducting transfer roller has a resistance of about 10³Ω to about 10⁹Ω.

18. An elastomer foam of an image forming apparatus, comprising:
one or more elastomers;
a conductive additive material; and
a nucleating agent.

19. The elastomer foam of claim 18, wherein the conductive material comprises an amount of liquid thiphene is between about 1 and about 4 phr with respect to the weight of the one or more elastomers.

20. The elastomer foam of claim 18, wherein the conductive material comprises a heterocyclic compound with sulfur in each chain.

21. The elastomer foam of claim 18, wherein the nucleating agent is wood powder.

22. The elastomer foam of claim 18, wherein an amount of the nucleating agent in the elastomer foam is between about 0.2 to about 6 phr with respect to the weight of the one or more elastomers.

23. The elastomer foam of claim 18, wherein a particle size of the nucleating agent is between about 30 μm and about 120 μm.

24. The elastomer foam of claim 18, further comprising:
a plurality of cells, each of the plurality of cells having substantially the same size.

25. The elastomer foam of claim 24, wherein the size of each of the plurality of cells is about 50 μm to about 120 μm.

26. The elastomer foam of claim 24, wherein a density of the plurality of cells in the elastomer foam is substantially uniform.

27. The elastomer foam of claim 24, wherein the density of the plurality of cells in the elastomer foam is between about 0.5×10⁶ and about 9.0×10⁶ cells/cm².

28. A method of making an elastomer foam, the method comprising:
adding a conductive material and a nucleating agent to one or more elastomers to form a blend; and
adding at least one chemical blowing agent to the blend to form an elastomer foam.

29. The method of claim 28, wherein the adding the at least one chemical blowing agent to the blend comprises adding an amount of the at least one chemical blowing agent between about 5 to about 7 phr to the blend.

30. The method of claim 28, wherein the at least one chemical blowing agent is selected from a group consisting of azodicarbonamide, p,p′-oxybis(benzenesulfonylhydrazide), p-toluene-sulfonylhydrazide, N,N′-dinitrosopentamethylenetetramine, and benzenesulfonyhydrazide.

31. The method of claim 30, wherein a decomposition temperature of the at least one chemical blowing agent is about 160° C. to about 180° C.

32. A method of making a transfer roller of an image forming apparatus, the method comprising:
molding an elastomer foam made of one or more elastomers, a conductive material, and a nucleating agent using an extruder.
